(19) United States
(12) Patent Application Publication
(10) Pub. No.: US 2007/0244744 A1
(43) Pub. Date: Oct. 18, 2007

(54) SYSTEM AND METHOD FOR SELECTING A POLITICAL CANDIDATE

(76) Inventors: ED SPATZ, DALLAS, TX (US); WADE McDONALD, Plano, TX (US)

Correspondence Address: HOWISON & ARNOTT, L.L.P, P.O. BOX 741715, DALLAS, TX, 75374-1715, US

(21) Appl. No.: 11/467,470

(22) Filed: Aug. 25, 2006

Related U.S. Application Data
(60) Provisional application No. 60/792,633, filed on Apr. 17, 2006.

(51) Int. Cl. G06F 11/00

(52) U.S. Cl. 705/12

(57) ABSTRACT

Conducting a first series of screening events on one at least one group of potential candidates to produce a set of potential nominees is disclosed. Publicly conducting a second series of screening events on the set of potential nominees and conducting a series of voting processes to sequentially reduce the set of potential nominees to a single nominee is disclosed.

### CROSS REFERENCE TO RELATED APPLICATION

This application claims the benefit of U.S. Provisional Patent Application No. 60/792,633, filed Apr. 17, 2006, entitled “SYSTEM AND METHOD FOR SELECTING A POLITICAL CANDIDATE”, which is herein incorporated by reference.

### TECHNICAL FIELD OF THE INVENTION

This invention is related to democratic elections generally, and, more particularly, to a system and method for selecting one or more candidates to run in an election for a political office.

### BACKGROUND OF THE INVENTION

As ancient societies progressed from hunter-gatherer groups, tribes, and nomadic existences, the need of a reliable and just way for a government, either local or national, to serve and protect its citizens has become increasingly important. Monarchies and totalitarian regimes may face the ongoing risk of revolutions as a competing factions have historically sought to take power by force. Sometimes the government's own constituents can be recruited for participation in revolts, either through coercion, or based up on a belief that the new regime will offer better conditions or protections than the last.

Revolutions can be devastating to the populace and the economy of a nation. Thus, the need arose for a method for ordinary people to be able to govern themselves or at least substantively participate in government. Democracy as a form of self government has been around for thousands of years, although the extent to which the ordinary citizen has been eligible to participate in the government has varied. The simplest form of democracy for small groups of participants is perhaps the direct democracy. However, a direct democracy is unworkable for large states such as those of the modern world. Moreover, a bare direct democracy leaves room for the minority to be exploited by the majority. Complex republican systems of governance have evolved over time to satisfy the basic needs for the individual to be protected while the populace retains the ability to express its desires through an elected government. However it is just these complications and the bureaucracies that seem to be inherent in modern governments that make modern day democracies subject to diminishing interest by the populace. The common citizen may feel that his or her government is out of tune with the majority and that there is little he or she can do to effect meaningful chance.

In the modern age of instant communications such as email, voicemails, and the internet, the United States Government, may appear to be even less responsive than in times past. Rarely does the citizen deal with any institution that is as slow to respond or adapt as the federal government. Indeed, the lack of voter turnout in the US, compared even to other democracies around the world would suggest that either Americans are extremely content with the status quo, or that they feel that there is no chance that their vote will make any real difference in their lives. The general consensus appears to be that the latter is the correct opinion. The complication of modern election systems and the apparent lack of choice in the two party system seems to have driven many voters to complacency in spite of the general feeling that something should be done to improve the system

A particular area of frustration with some voters is that they feel that modern candidates are rarely forced to give frank or detailed opinions on matters and that modern democracy and campaigning is being reduced to sound bites. Additionally, the complicated primary and caucus systems used to select major candidates, and the complicated election systems for major offices such as the U.S. Presidency further serves to alienate the voters that the government is charged with representing.

In the 2000 U.S. Presidential election, many voters were dismayed to realize that it was not his or her vote that elected a president but that the vote selected a member of the Electoral College. Thus, the controversial election demonstrated that it was possible for one to become president who did not attain the largest percentage of the popular vote. This and the subsequent court battles between the major political parties has continued to lead voters to believe that our current system is out of tune with the true majority of the country

Therefore what is needed is a system and method to address the above, and related, issued.

### SUMMARY OF THE INVENTION

The present invention disclosed and claimed herein, in one aspect thereof, comprises a method for choosing a political candidate. The method includes establishing a location providing applications for persons to participate in a contest-based political nominee generating event for a predetermined target political office, receiving completed applications for the contest-based event from a plurality of potential candidates, and pre-screening the applications received to produce a contestant pool of persons who applied who also meet the requite qualifications of the target political office. The method also includes judging a first series of tasks performed by individual members of the contestant pool and eliminating at least one contestant from the contestant pool based on the judging. The method includes providing a viewing audience with access to observe a second series of tasks performed by the remaining individual members of the contestant pool, providing commentary on the performance of the remaining individual members of the contestant pool in performing the second series of tasks, and taking a vote of the viewing audience to eliminate at least one of the remaining members of the contestant pool.

The present invention disclosed and claimed herein, another aspect thereof, comprises a system for choosing a political candidate for a target office. The system includes a location providing applications for persons to participate in a contest-based political nominee generating event for a predetermined target political office, and receiving completed applications for the contest-based event from a plurality of potential candidates. The system includes a pre-screening center that screens the completed applications to produce a contestant pool of persons who applied who also meet the requite qualifications of the target political office, a facility for a viewing audience to observe a second series of tasks performed by the remaining individual members of the contestant pool, and a judging panel that judges a first series of tasks performed by individual members of the contestant pool and eliminates at least one contestant from the contestant pool based on the judging and provides commentary on the performance of the remaining individual members of the contestant pool in performing the second series of tasks. A voting system for polling the viewing audience to eliminate at least one of the remaining members of the contestant pool is provided

The present invention disclosed and claimed herein, another aspect thereof comprises a method for selecting a candidate for a political office via a series of televised competitions. The method includes accepting completed applications for possible contestants for the program,

pre-screening the applications and producing a set of contestants, producing a first set of episodes showing a set of competitions observed by a judging panel, the judging panel voting to eliminating at least one of the contestants from the series, producing a second set of episodes showing a second set of competitions observed by a judging panel and a viewing audience, the viewing audience eliminating all but one contestant from the series. The judging panel provides commentary to the viewing audience regarding the contestants and the second set of competitions.

The present invention, disclosed and claimed herein, in another aspect thereof comprises a system for choosing a political candidate for a target office. The system includes a plurality of application reception stations to receive contestant applications, a screening center that eliminates contestants without required credentials to run for the target office in a general election for the target office, and a judging panel that eliminates a first predetermined number of contestants from eligibility to win. A production studio producing a series of programs for viewing by a viewing audience wherein the contestants engage in a series of competitions illustrating their suitability for the target office and a voting system for polling the viewing audience to determine a winner of the series of competitions is also provided.

The present invention, as disclosed and claimed herein, in another aspect thereof comprises a method for selecting a political candidate. The method includes conducting a first series of screening events on one at least one group of potential candidates to produce a set of potential nominees, publicly conducting a second series of screening events on the set of potential nominees, and conducting a series of voting processes to sequentially reduce the set of potential nominees to a single nominee.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a block diagram of one embodiment of a system for selecting a political candidate according to aspects of the present disclosure;

FIG. 2 illustrates a flow diagram of one embodiment of a method for selecting a political candidate according to aspects of the present disclosure;

FIGS. 2a, 2b and 2c illustrate additional flow charts for the operation of prescreening;

FIG. 2d illustrates a flow diagram of another method for selecting a political candidate according to aspects of the present disclosure;

FIG. 3 illustrates a flow diagram of another embodiment of a method for selecting a political candidate according to aspects of the present disclosure;

FIG. 4 illustrates an organizational diagram depicting one embodiment of a method of organizing a broadcast of a method of selecting a political candidate according to the present disclosure;

FIG. 5 illustrates a set of possible courses of actions for a successful contestant of the system and method of the present disclosure;

FIG. 6 illustrates an organizational diagram of one embodiment of a campaign management team according to aspects of the present disclosure;

FIGS. 6a and 6b illustrate flow charts for the funding operation; and

FIG. 7 illustrates a flow diagram of another embodiment of a method for selecting a political candidate according to aspects of the present disclosure.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

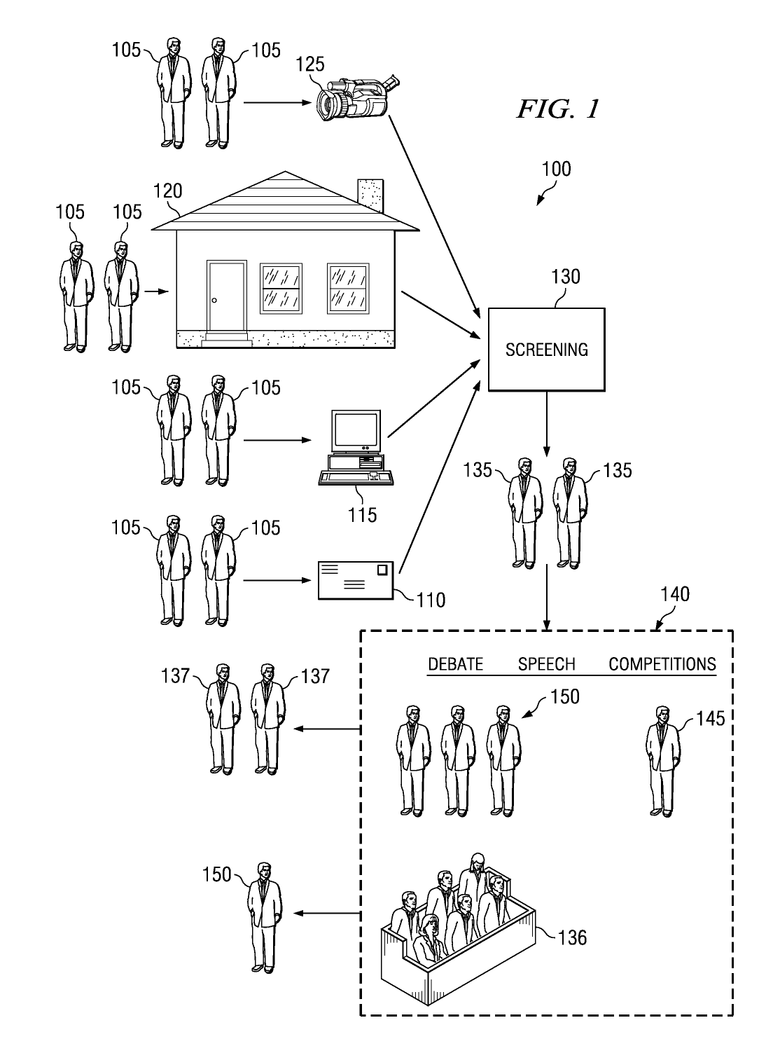

Referring now to FIG. 1, a block diagram of one embodiment of a system 100 for selecting a political candidate according to aspects of the present disclosure is shown. The overall system 100 is intended to allow a relatively large number of potential candidates 105 to be considered for a given office. The office for which the system 100 is selecting candidates is the target office of the system. The system 100 produces a candidate to run for election to the target office. The system 100 is designed to eliminate unqualified, and possibly the most under qualified, candidates early in the process. Through a series of competitions and other events, as will be described herein, potential candidates are selectively vetted until a manageable candidate pool remains. In one embodiment, this will result in a candidate pool of 10 to 20 people, but the present disclosure is not meant to be so limited. This smaller number of candidates can then be reviewed and evaluated thoroughly and publicly, and then voted on. In one embodiment, this can be an iterative process that repeatedly removes the least favorable candidate or candidates until the winner is determined. The winner may then seek election to the target office with the support of the system 100 as described below.

The candidates 105 will typically be anyone who is interested in running for a specific political office (e.g., the target office). In some cases, a candidate 105 may not be expressly interested in the target office, but his or her peers may have an interest in having the candidate 105 run for the office. In one embodiment, the present system 100 is meant to select a candidate for the office of President of the United States. However, the present system 100 is not so limited and would be suitable for selection of candidates for other offices, including but not limited to congressional seats, state and local representatives, governorships, judgeships, and mayoral offices.

The system 100 is also capable of accepting candidates from a plurality of sources. By way of example, these sources may include postal mail 110, computer based submissions 115, in-person submissions 120, and televised submissions 125. Candidates 105 may express their desire to become a candidate via a mail-in application or questionnaire. In cases where the target office has express statutory requirements for candidates, the candidate 105 may be required to provide certain credentials. These may include proof of residency, citizenship, age, etc. In a case where someone is submitting a third party to become a candidate, it may be possible to accept the application without credentials showing the prerequisite qualifications, and these may be verified at a later time if the candidate 105 chooses to participate in the system 100. A computerized application could also be used. Such application could also be submitted via the internet using a computer 115. The application, whether paper or electronic, may provide basic information about how the system 100 operates as well as providing information regarding the target office for which the candidate is being nominated. The internet solution has the advantage of being more dynamic and additional and optional content may also be provided at little or no additional cost.

Candidates 105 may also apply in person at an application facility 120. Such application facility 120 may be set up in a public location or a dedicated office building that has been purchased, leased, subleased, or borrowed for the use with the system 100. Candidates 105 who apply in person may either fill out a paper form or possibly utilize a computer terminal. The application facility 120 may be staffed by those knowledgeable regarding the system 100 as well as the target office being sought by the candidates 105. Credentials such as proof of residency and citizenship may be verified by staff of the application facility. An additional means by which candidates 105 may be sought involves setting up a video camera 125 or other media recording device at a location where candidates may wish to appear in person. The camera 125 may be set up to run at a library, a public park, a college campus, or other area frequented by potential candidates. Local news and media stations may be able to submit candidates that may be local celebrities, activists, or other personalities. As before, anyone would be free to nominate themselves or a third party. The supplying of proper credentials may be postponed until a later stage of the system 100.

Aside from very basic screening such as citizenship and residency requirements, most of the preliminary screening of candidates will happen at a screening center 130. The screening center 130 may be a productions studio or office suite. In some embodiments, the screening center 130 is not a physical location, but may be a virtual office or online collaboration or meeting. The screening center 130 serves to apply some basic filtering to the candidates 105. In some embodiments, credentials may be verified by the screening center 105 if needed. Candidates 105 that were nominated by a third party may also be contacted by someone from the screening center to determine if the nominated person actually wishes to bid for candidacy and to determine if such person would cooperate fully with the system 100. Due to the mechanisms used in determining final candidates by the system 100, all candidates 105 may be required to agree to have their likenesses reproduced for use and promotion of the system 100.

In addition to screening for, or verifying, basic credentials and obtaining requisite permissions, the screening center 130 may also apply some basic filtering on candidates based on likelihood of success within the system 100 and possibly in any public election to finally select the winner of the target office. The present system 100 is not designed to sift out candidates with alternative viewpoints; on the contrary, the system 100 is designed to allow the public to have access to a viable candidate who may not otherwise have a platform or money to run for a given target office. However, due to the number of applicants, the screening center 130 may be required to discard a certain number of candidates 105 based upon the reality of the demands of ultimately winning and election and successfully executing the target office. For example, the screening center 130 may eliminate those candidates 105 having a criminal background. In some embodiments, the screening center may actually request background searches on candidates 105, particularly when the target office has requirements relating to criminality. Known con artists would be another possible category of candidate 105 to be eliminated by the screening center 130. Candidates 105 may also be eliminated who are able through other means to legitimately run for office (e.g., likely candidates for a major political party). In some embodiments, the screening center 130 will have wide latitude regarding which candidates 105 are ultimately allowed to participate in the system 100. The reality of the time and monetary commitment involved to operate the system 100 necessarily means that every candidate 105 with the requisite credentials may not be allowed to participate in the system 100. However, choosing candidates 105 that are too similar to those already available through the major political parties could mean the any candidate 105 ultimately chosen by the system 100 may not have the chance to differentiate himself or herself enough to get voters interested in voting for them.

Through the process of eliminating candidates 105 unlikely or unable to succeed in an election and execute the target office, the screening center 130 will produce a set of contestants 135. The contestants 135 proceed into a contest portion 140 of the system 100. The contest portion 140 may be adaptable to the needs and wants of the contestants 135, a viewing audience 136 (which may include a home audience and/or a studio audience), and/or network sponsors. In one embodiment, the contest portion 140 of the system 100 will be taped or recorded, broadcast live, or a combination thereof. In some embodiments, some of the contest portion 140 will be webcast or available through other media outlets such as video blogging, podcasting, and the like. In some embodiments, the system 100 may provide a combination of these methods to allow the viewing audience 136 to participate and follow the contest portion 140 to the degree desired. For example, supplemental educational material relating to a given broadcast or taping may be made available online through a website associated with the contest portion 140 or the whole system 100.

The contest portion 140 may feature multiple methods for the contestants 135 to make themselves known and distinguished, both as regarding one another, and as regarding the typical candidate advanced by one of the major political parties. As stated, the contest portion 140 may be flexible and the current disclosure is not meant to be limited to a specific contest portion format. One purpose of the contest portion 140 is to allow the viewing audience 136 to absorb as much information regarding the contestants 135 as possible. An additional purpose is to provide background education to the viewing audience 135 concerning the target political office that the contestants 135 are seeking. Such education may include historical information concerning past office holders, the responsibilities of the office, statistics related to the office, and actual powers and responsibilities of the office. All or a portion of the contest portion 140 may be broadcast live or recorded for later broadcast, for streaming from the web, for podcasting, etc. Specific events related to the contest portion 135 will be described in greater detail below.

Someone may serve as host 145 of the contest in order to provide the viewing audience 136 with information and direction regarding the contest portion 140. Typically the host 145 will not have any substantive role regarding which contestant 135 is ultimately successful. The host 145 may serve as a master of ceremonies for any live or broadcast portions of the contest portion 140. In addition to the host 145 and the contestants 135, the contest portion 140 may feature one or more judges 150. In one embodiment, the judges 150 will be persons having a relatively deep knowledge of the political process, the target office, the issues likely to be faced by a successful candidate, the history of the office, or another relevant area. Some examples of possible judges may include past office holders, philosophers, clergymen, historians, political advisors, and others. In some embodiments, the judges 105 may optionally include one or more lay persons chosen at random or through an application process.

The judges 150 do not necessarily determine the final outcome of the contest portion 140. However, the judges 150 may have some degree of discretion regarding the elimination of very unqualified contestants 135. In one embodiment, the judges 150 may be able to hold periodic votes on the fitness of a contestant 135. A contestant 135 could be eliminated based upon a majority vote of the judges 150. In other embodiments, the judges 150 may be required to vote unanimously before a contestant 135 can be eliminated. In yet another embodiment, the judges 150 may not eliminate a candidate 135 at all, but may only provide advice to those who select the winning contestant (e.g., the viewing audience 136). It is also possible that the judges 150 may serve to eliminate contestants 135 early in the contest portion 140, and then move into an advisory role later in the contest portion 140.

The contest portion 140 of the system 100 may feature a wide variety of contests and tests intended, in part, to reveal as much relevant information regarding a contestants 135 as possible. In one embodiment, the judges 150 or the host 145 may require the contestants 135 to answer a number of questions in an extemporaneous manner. The questions may be designed to require the contestants 135 to each commit to view point or address a particular issue that reveals the contestant's actual opinion on a given issue. If one or more of the judges 150 feels that the contestant 135 has not addressed the question, the question could be reworded or asked again, and the contestant 135 given another opportunity to respond. In some embodiments, if each of the judges 150 feels that the contestant has evaded the question, the judges 150 would have the option of dismissing the contestant 135 with a unanimous vote. In other embodiments, a majority vote would suffice.

The judges 150 and/or the host 145 may pose questions for the candidates 135 to answer. This may be done as a live broadcast event, as a taped event, or a combination thereof. The topics that may be covered can include virtually anything wholly or partially relevant to the target office, the person, the political process, the history of the target office, or other areas. A partial list of exemplary topics for questions includes human rights, religion in governance, hate crimes, judicial issues, police actions, gay rights and marriage, the war on drugs, legalizing drugs, free trade, international relations, the cost of health care, natural disasters, epidemics, terrorism, port security, the environment, crime, education, poverty, transportation, taxes, special interest groups, gun control, gangs, illegal aliens, the death penalty, foreign imports and trade deficits, government subsidies, and the voting and election process in the United States and/or the states themselves.

In addition to being asked open ended questions, the contestants 135 may also each be asked to formulate a response to how he or she would handle a specific situation. Here the judges 150 may wish to take special care to make certain that when a contestant 135 responds to a particular issue, that the contestant 135 has actually responded to the specific fact pattern provided. It may be important to the outcome of the contest portion that the candidates use this time to provide a specific response to a specific theoretical situation rather than using the time to indicate their general attitudes or policy thoughts. In one embodiment, the specific situation presented by the judges 150 could be an actual current and topical happening or event which may be in the news and therefore fresh on the mind of the viewing audience 136.

Debating may also be used to allow the viewing audience the opportunity to hear out the view points of the contestants. Traditional debate formats may be used. For example, a contestant 135 may be asked a question or given a topic and then given a predetermined amount of time to address the question or topic. Another contestant 135 may be given a chance to respond or rebut, possibly followed by a reply from the first. Since early on in the contest portion 140, there are likely to be many contestants 135, the debate rules could be modified. For example, each of the contestants 135 may be allowed a predetermined time frame in which to address the topic or issue with limited or no rebuttal or replies. Topics for the debates may be chosen by the judges 150, the host 145 or even the contestants 135 themselves. In one embodiment, questions or topics may be submitted by the viewing audience 136, via telephone, in person, or through a web page or portal.

In addition to the question and answer sessions, debating, and other devices described above, the contest portion 140 may feature more nontraditional methods of obtaining information concerning the contestants 140. For example, intelligence tests may be administered to the contestants 136, and the results shared with the viewing audience 136. Logical or language puzzles may also be used. These could be shown live, taped, webcast, or otherwise made available to the viewing audience 136. In another embodiment, only the scores may be reported to the audience 136. The judges 145 may be given the opportunity to comment on the scores or the relevancy of the tests both as regarding the contestants 135 themselves and the target office in general. Competitive mental challenges could be used such as chess matches or other events that correspond to different strengths and weakness. Physical fitness tests could also be administered during the contest portion. In one embodiment, the tests may be competitive, such as a timed obstacle course, a foot race, bicycle rate, or swimming event. The contestants 135 could also be examined by physicians including having full physical workups to determine if any of the contestants 135 had any drug abuse or alcohol problems or otherwise had any health problem affecting their ability to execute the target office. Although it is understood that not every quality or score indicated by performance in these tests will necessarily have a direct bearing on the ability to execute the offices, such tests or trials would give critical information to the viewing audience concerning the ability of the contestants 135 to deal with issues affecting their personal lives in a public forum, as modern politicians often find themselves doing.

In addition to the competitions and challenges described above, the contestants 135 may also be given the opportunity to have a specified amount of time to present to the viewing audience 136 in a free form manner. Contestants 136 may give a live or prerecorded speech. Essays and additional material could also be prepared by the contestants for distribution to the viewing audience 136. In some embodiments, the contestants will have a weblog associated with the contest portion 140 where they may post in an open manner. In this way, additional material that may not be presented to the viewing audience 136 live due to time constraints could be made available via the internet. Similarly, before, during, and after the contest portion 140, the system 100 may have a website or portal providing additional educational materials and commentary. Thus the viewing audience 136 may view material related to the system 100 to the extent needed to follow and understand the happenings of the contest portion 140.

There are many possible combinations of prerecorded and live events in the contest portion 140. In one embodiment, the contest portion 140 and possibly other elements of the system 100 are intended to run as a television show or series. This show could also be wholly or partially distributed over the internet or by other means. A portion of the television show embodiment could be prerecorded so that it could be time-edited to run within a specified time slot on a television network. The show may, in some aspects, simply be highlights of the overall process or system 100 of selecting the nominee. Material not appearing on the air could be made available via a website or web portal. The website may also provide weblogs for the contestants to add additional material not made available during a specific event of the contest portion 140. Similarly, the judges 150, the host 145, or even audience members 136 may be able to post to blogs or create blogs reflecting the happenings of the contest portion 140 and other portions of the system 100.

In addition to airing part or all of the contest portion 140, the television program, the associated website and/or blogs may be used to educate the viewing audience 136 as to the process of the election in which the winner of the contest portion 140 may participate for ultimate selection of the winner of the target office. The educational component may be emphasized to a greater degree where the selection of the nominees and winner of the election is not a straightforward process. For example, a portion of one or more episodes may be devoted to explaining to the viewing audience 136 how the Electoral College system for selecting the US president works. Terms, term limits, campaign regulations, and office qualifications could also be the subject of education material for the viewing audience 136. Explanations may also be given to cover the political party systems and primary systems in the United States relating to the target office. Links may also be provided on the associated website to other websites that could provide additional information.

At or near the conclusion of the contest portion 140, the viewing audience 136 may be asked to vote to select the final winner. There are several possibilities for voting to select the winner. In one embodiment, viewing audience 136 would be allowed to vote by phone, mail, internet, text messaging, or other methods. The voting may be open such that anyone can vote, possibly more than once. In another embodiment, only one vote per day from each member of the viewing audience 136 may be allowed. A single vote from any one viewing audience 136 member is another possibility. In some embodiments, there may be a registration requirement prior to voting. The registration could be simple such as a web-based form. The registration to vote could also include registration to access additional content relating to the contest portion which may be available on a website relating to the show. In one embodiment, following a predetermined number of possible eliminations by the judges 150, the viewing audience 136 may sequentially vote for one or more of the contestants 135 to be dismissed from the contest portion 140 and become dismissed contestants 137. In one embodiment, one contestant 135 will be eliminated for each episode of the television show associated with the contest portion 140.

It should be noted that it is not required that a contestant be eliminated in each episode and the present disclosure is not meant to be so limited. Moreover, in another embodiment, contestants 135 could be organized into teams or parties (which may or may not correspond to actual political parties). In such an embodiment the judges150 and/or viewing audience 136 may select winners from between the teams during the contest portion. The teams may elect a leader or frontrunner who may be demoted from this position based upon a poor performance or loss on by the team. In one embodiment, the demoted team leader would be eligible to become team leader again if the newly elected team leader is subsequently demoted. As the contest portion 140 progresses, the teams may be broken up or rearranged as progression is made toward selecting as the winner 150 of the contest portion.

In one embodiment, the contest portion 140 has a provision for one or more contestants who have been eliminated 137 to return to the competition. The contestants 137 may have been voted on by the judges or by the audience. At some point during the contest portion 140 the viewing audience 136 may be given the opportunity to vote to select one or more of the contestants eliminated 137 by the judges or otherwise to return to the contest portion 140 to be voted on by the viewing audience 136 for a chance at being selecting as the winner 150 or nominee. In such case, one or more of the contestants 137 having been eliminated earlier in the contest portion 140, may continue to participate in at least some of the remaining events of the contest portion 140. This mechanism gives a particularly popular eliminated contestant 137 a chance to comeback and be a winner. However, since one, or only a limited number, of those contestants voted off 137 can return to the competition, the odds of an eliminated contestant 137 becoming the winner 150 are greatly reduced.

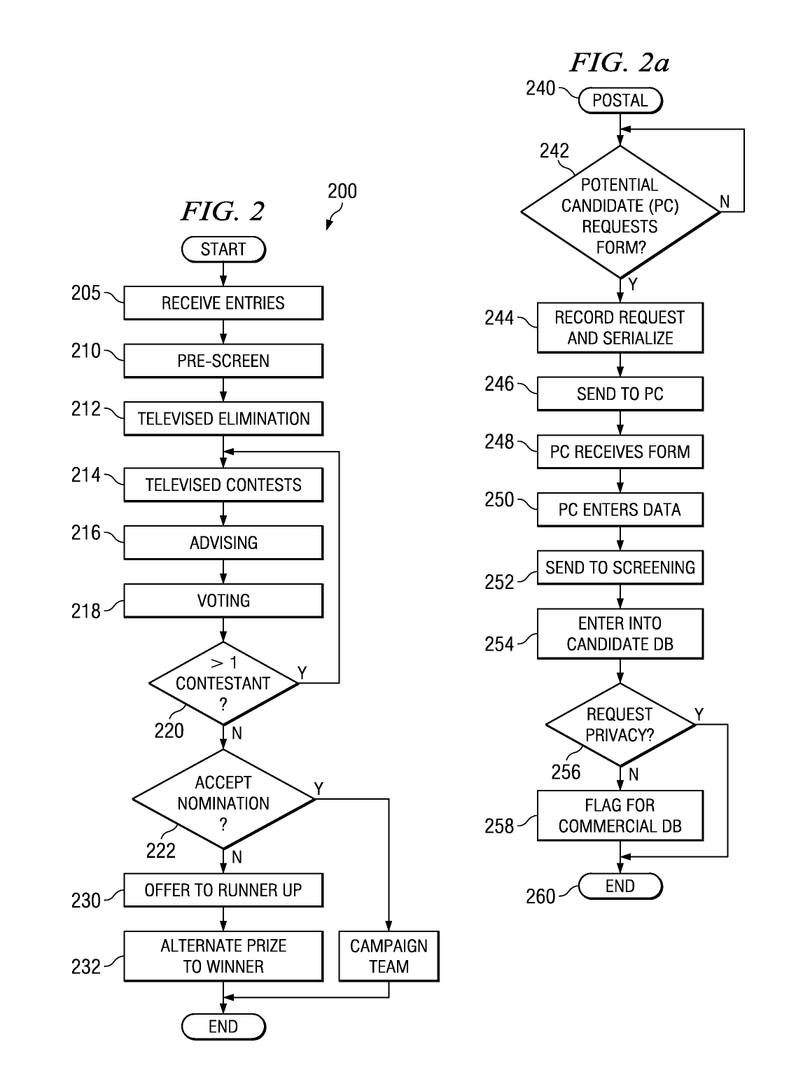

Referring now to FIG. 2 a flow diagram 200 of one embodiment of a method for selecting a political candidate according to aspects of the present disclosure is shown. The embodiment shown in FIG. 2 has a televised and non-televised portion that includes contestant elimination by judges and by the viewing audience. Beginning at step 205, entries are received. The entries may be nominations for the target political office of the method shown. As previously described, the entries or nominations may be taken from a number of sources such as postal mail or the internet and may be submitted by the entrant themselves or by a third party. At step 210 the entries are pre-screened. The prescreening may include eliminating such entrants as fail to meet the statutory requirements of the target office. The prescreening step 210 may also be used to determine if any third party nominated entrants do not wish to participate. Typically, the prescreening at step 210 will not be recorded or televised although it could be.

Following the prescreening step 210, a televised elimination at step 212 may begin. The televised elimination at step 210 may be broadcast live, webcast, or recorded and produced into one or more episodes as part of a series chronicling the method of selecting a political candidate 200. In one embodiment, the entrants may answer questions, perform tasks, take tests, and the like in front of one or more judges who may vote to eliminate one or more of the entrants. Typically, only the judges will make eliminations of entrants at step 210. In one embodiment, all of the judges are required to vote to eliminate an entrant before such entrant is actually eliminated (e.g., unanimous voting).

At step 214 a series of televised contests are performed. The entrants may be required to participate in a wide array of contests ranging from debates to physical examinations or competitions. Some such contest events were described in regards to the contest portion 140 of FIG. 1. Following one or more contests at step 214, a panel of judges may advise the viewing audience regarding the performance of the contestants at step 216. The audience will vote to remove one or more contestants from the competition at step 218. Typically, it will only be the audience members that vote during step 218 and the judges will be relegated to an advisory role. At step 220, if there are still contestants to be eliminated, the process repeats starting at step 214. It can be appreciated from steps 214, 216, and 218 that an iterative process is involved. Each televised contest 214 may be followed by an advice session at step 216 and a voting session at step 218 resulting in one or more contestants being eliminated from the competition. Each time these steps are repeated, the steps may be produced into a single televised episode. Following the requisite number of episodes, a final winner will have been decided when there is only a single contestant remaining at step 220.

The winner of the contest, having been chosen by a combination of prescreening, judge selection, and audience voting will be able to choose at step 222 whether or not to accept the prize and become the contestant finally selected as the nominee for the target office. If the winner accepts the nomination or official candidacy at step 222, the candidate will be assisted in become a ticketed contender in the election for the target office at step 224. The options available for assisting the winner will be described in greater detail below. If the winner elects not to accept the candidacy at step 222, the honor may be offered to the second place contestant at step 230. An alternate prize, such as a monetary prize, may be offered to the original winner at step 232. In this manner, the possibility of having a winner who is not genuinely interested in pursuing the target office is mitigated.

Referring now to FIG. 2a, there is illustrated a flow chart depicting the prescreening operation wherein the postal system is utilized. This is initiated at a block 240 and proceeds to a decision block 242 to determine if a potential candidate (PC) has requested a form. The manner of providing a form to a potential candidate can vary. It could be provided through a newspaper, a flier or another method. However, one embodiment would be that the PC must take some steps to actually acquire the form through some type of request from a governing body for the contest. This forces the PC to contact the governing body. When the request is made, the program proceeds along a “Y” path to a function block 244 wherein the governing body records the request and then serializes a form to be sent to the PC. By serializing this form, this requires the governing body to record when the request was made, by whom the request was made (if only with the name of the requester) and then provides some type of serial number or tracking number on a document to be transmitted to an address. In this manner, the governing body will have an address and name for a requestor. This can be utilized by the governing body to create a mailing list which can be valuable in and of itself.

Once the form has been serialized and logged into the database, this request form is then sent to the requesting PC, as indicated by a function block 246. The PC then receives the form, as indicated by a function block 248 and then enters data into this form, as indicated by a block 250. This entry of data provides such things as the requestors name, address, religious affiliation, preferred political party, background information, contact information, such as phone number and e-mail address, etc. This can be a very comprehensive form or a very abbreviated form.

After the requesting PC enters all of the necessary data into the various fields, this form is then sent to the screening body 130 for the purpose of screening, as indicated by a function block 252. The data is then extracted from the form and entered into a candidate database, as indicated by a block 254. Once entered into the database, this data may become valuable, as it provides a large amount of information about the demographics of the contest. As is well known in the art, the value of the database can sometimes far exceed the value of the contest, as it is anticipated that far more potential candidates will apply as opposed to the ones that are actually accepted. Thus, there will be some type of check box or the such associated with the form that will allow the person to request privacy or to allow their information to be utilized for other purposes. This, of course, depends upon the various privacy laws that are in place at the time the form is filled in or which may be placed into regulation at a later time. If the party has requested privacy, as indicated by a decision block 256, the program will merely go to an End block. However, if the party has not requested privacy, or if the local or federal regulations do not require the information to be maintained private, the program will flow along the “N” path to a function block 258 in order to flag this information for a commercial database and then proceed to the End block 260. Once this information is in the commercial database, this provides a valuable tool for raising funds for the overall program.

In addition to storing candidate data as described above, the database may also be used to store information obtained from user or viewers polls corresponding to the system described herein. The polls may be conducted by phone or computer, possibly with authentication to ensure integrity of the data as herein described. The polls may cover issues directly related to the system for selecting a political candidate. The polls may also cover ancillary or additional information corresponding to the political process in general. In some embodiments, this additional information may prove valuable for sale or lease. The additional information may also be used to inform the process of the overall system to make certain that the contest portions and other portions closely match viewers and voters expectations.

Referring now to FIG. 2b, there is illustrated a flow chart for utilizing the Internet for prescreening. This is initiated at a block 262 and then proceeds to a function block 264 in order to access a website. This website could be advertised on various types of media and the like in order to attract the user to a particular website. Once the user is attracted to the website, the user will be presented various web screens that will inform the user of the rules of the contest, the requirements for potential candidates (PC) and provides the rules of the contest. After the user has read the contents of the website, the user will then be provided the opportunity to select an application. The user will select the application by “clicking” on a particular area on the web page, as indicated by a function block 266. The program then flows to a function block 268 wherein the form is sent from a clearing house associated with the governing body to the computer associated with the PC. The program then flows to a function block 270 in order to prompt the individual to fill out the information. With the web page application form, there can be an interactive session that allows a user to obtain help about any particular field, to gain information about what is required, to allow the governing body to insist on certain fields being filled in, i.e., typically noted as “required fields” and allow a complete application to be filled in. The advantage of the electronic form is that it can be placed in a form that is immediately transferable to a database. The type of information that is provided would be such things as name, as indicated by decision block 272, address, as indicated by a decision block 274, political affiliation, as indicated by decision block 276, age, as indicated by decision block 278, experience, as indicated by decision block 280, citizenship, as indicated by decision block 282, references (in the form of individuals that would verify the credibility of such an individual), as indicated by a function block 284, and other such inputs. The program then flows to a function block 285 in order to complete the form by accepting the rules of the contest, indicating whether they wish to keep the information private, etc. The program then flows to a function block 286 to send the information via a secure server and then to a function block 288 wherein a password and user name are provided by the governing body to the applicant. This allows the applicant to check on their application to determine if they have been selected. Thereafter, this information is entered into the candidate database in the sequence set forth hereinabove with respect to FIG. 2a with blocks 254, 256, 258 and 260. These all operate substantially identical except that the entry into the database is automatic. Like numerals refer to like blocks in these two figures. The program then flows to a function block 290 after all processing.

Referring now to FIG. 2c, there is illustrated a flow chart depicting the operation wherein prescreening is facilitated with a camera. This particular prescreening process is initiated at a Start block 291 and then proceeds to a function block 292 wherein a connection is created. This connection can be, as described hereinabove, a camera placed at a particular kiosk or similar location wherein a two-way or a one-way communication is provided which can be accessed by a potential candidate. The potential candidate must access the camera and provide certain basic information thereto. Once the connection is created, then it is necessary to facilitate this transferred information. In one option, as indicated by a function block 293, it may be that the governing body of the contest would like to have the potential candidate provide some type of application fee or initial fee. This would possibly filter some of the useless recording that could occur due to potential candidates that are really not serious candidates but are merely utilizing the system for amusement. However, it is also possible that the more “amusing” individuals that are interviewed via the camera option would provide valuable footage for other purposes. However, even if the fee is not chosen, there is some initiation that will start a session. This is indicated by a function block 294 wherein the video connection is initiated and then goes into a record mode, as indicated by a function block 295. This record mode continues until the user selects to end it or, in a two-way connection, the governing body terminates it. Further, this camera could have the ability to scan, take video pictures at different angles for the use of multiple cameras, etc. During the recording operation, the amount of footage that is retrieved can be varied depending upon various user options. However, there will be some type of question and answer back and forth between the candidate and the camera, even if they are prerecorded questions. Once all the questions have been asked and a certain amount of time allotted for answer, a particular session can then be terminated, as indicated by a decision block 296. This indicates when the end of the recording session has occurred. At this point, there is a feature anticipated wherein the information could either be archived at the kiosk or location where the video is created or it could be transferred back to a central clearing house. This is indicated by a decision block 297 wherein an archive flag can be set to store the information, as indicated by a decision block 289 and then a later retrieval, indicated by a decision block 287. This retrieval operation could be a manual retrieval operation or an electronic retrieval operation. The program would then transfer to an End block 285. However, if the archive flag is not set, then the information regarding the video would be directly sent to the screening body 130, as indicated by a function block 298 and then to the End block 285.

It can therefore be seen that the video prescreening operation provides a number of advantages. First, it could be a non-monitored operation where the user is prompted for questions either by a prerecorded video transmission of an individual asking questions, text questions provided on the screen or it could be a real time operation. The information that is collected would somehow be associated with a particular individual through their address, name, etc. and they could be asked a very specific question asking whether they wish this information to be maintained private or they would allow the information, in accordance with contest rules, to be utilized for other purposes. This is very typical with photographers that take photographs and pay individuals for the “modeling” time such that they can utilize these photographs in any way they deem fit at a later time. If there is some way to achieve this with the individual without actually requiring them to sign a document, then this video footage could be utilized for later programming during the contest or for a different purpose.

Referring now to FIG. 2d, a flow diagram of another method for selecting a political candidate according to aspects of the present disclosure is shown. The flow diagram of FIG. 2d represents one additional method of use corresponding to the system shown in FIG. 1 and the other methods described herein. At step 2002 viewers or voters will register for participation with the system. Each viewer or voter may also select a particular primary party affiliation at step 2004. The party affiliations available to the viewers may or may not correspond to an actual political party existing at the present time. Once the affiliation has been selected at step 2004, the contest portion will commence at step 2006. The contest portion may include such contests and events as have been previously described or may include other contests unique to one of the particular party affiliations available to the viewers or voters. Following the contest portions at step 2006, primaries will be conducted at step 2008. In one embodiment, any particular viewer or voter will be limited to participation in the primary corresponding to the selected party affiliation from step 2004. Various means of voting may be utilized during the primary. These include, but are not limited to, electronic voting, Internet voting, voice voting or a traditional paper ballot voting. Drivers' license registrations and/or other forms of identification may be used to ensure proper voting security. In one embodiment biometric methods such as fingerprint scans or retina scans may be utilized to ensure that each voter or viewer is able to vote only a single time. In yet another embodiment, each registered voter may be given an identification code linked to a personal computer that allows for only one vote per computer. In some embodiments multiple votes per computer could be allowed in the instance of a family or group of people all utilizing the same personal computer. The number of primaries connected at step 2008 will correspond to the number of parties or affiliations available during contest portion. It will be appreciated that the present disclosure is not limited by the number of party affiliations or primaries conducted. Following the primaries at step 2008, when the winners of the primaries have been selected, optional contests or campaign events may occur at step 2010. These may be versions of contests previously described herein involving only the winners of the primaries from step 2008. Debates, campaign speeches, prerecorded addresses, web logs or other means of communication between the primary winners and the viewers or voters may be used at step 2010. At step 2012 a final vote will be conducted to select the winner of the overall process. Options for the winner and other candidates participating in the final vote at step 2012 will be described in greater detail below.

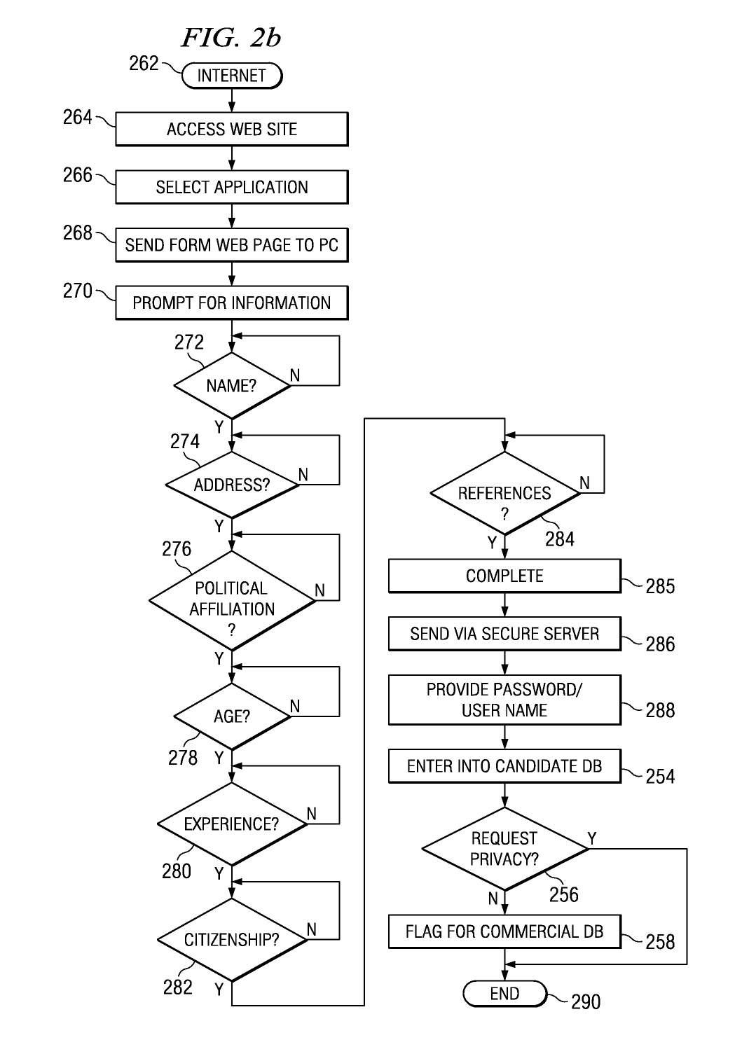

Referring now to FIG. 3 a flow diagram of another embodiment of a method for selecting a political candidate according to aspects of the present disclosure is shown. The flow diagram 300 illustrates additional detail on one possible way in which the system and method of selecting a political candidate of the present disclosure may be parsed into one or more episodes for airing on television or distributing through other means. A first episode may be aired (or otherwise distributed) at step 10 in which the judges eliminate one contestant. In the embodiment shown, the judges may be required or able to eliminate a contestant from those in the contest by a popular vote. Steps 12 and 14 are similar in that another contestant will be eliminated in each of these. As before, the elimination may be based on the judges' opinion following one or more televised or non televised events such as debates and the other contests described herein.

At step 16, a series of episodes may be distributed in which a viewing audience eliminates additional contestants based on a voting system. There may also be a series of additional contests or competitions. In one embodiment, each episode corresponds to the elimination of a single contestant and there are seven episodes. Thus, which each episode, the remaining candidates may each be featured more heavily than in the previous episode. The viewing audience will therefore be given correspondingly more information to make the choice of which candidate should be eliminated from the contest as the stakes for the remaining contestants become higher. The episodes distributed at step 316 may also be influenced by the judges to a degree. In one embodiment the judges do not vote for the eliminations but may still comment on the outcome of the contests and competitions.

At step 18 a final contest episode may be shown. The final contest episode may occur when there are only two contestants remaining. In one embodiment, the episode shown at step 18 could be somewhat of an open format. This would allow the two remaining contestants to put forth what each feels like is the best opportunity for the viewing audience to evaluate the contestants. Although the present embodiment has been described as having two contestants participate in the final contest episode, the present disclosure is not meant to be so limited. For example, three or more contestants could participate in the final contest episode at step 18. At the conclusion of the episode of step 18, voting may commence. In one embodiment, the winner will not be revealed until step 20. Thus, the final voting could take place over a number of days if desired.

As described, in some embodiments, it is possible for a candidate who was previously eliminated to return to competition. As shown in FIG. 3, a candidate may be brought back at step 22 from those eliminated by the judges at steps 10, 12, or 14. The eliminated candidate chosen to return to competition may be chosen by a vote from the viewing audience, by a competition against other eliminated candidates, by a vote of the eliminated or still-competing candidate, or by other means. The candidate returning to the competition may return relatively early during the contest portion of step 16 in order to allow the returned candidate the greatest opportunity to gain support for the possibility of winning the final vote at step 18. In one embodiment, the returned candidate may be immune from a subsequent, second elimination by the judges.

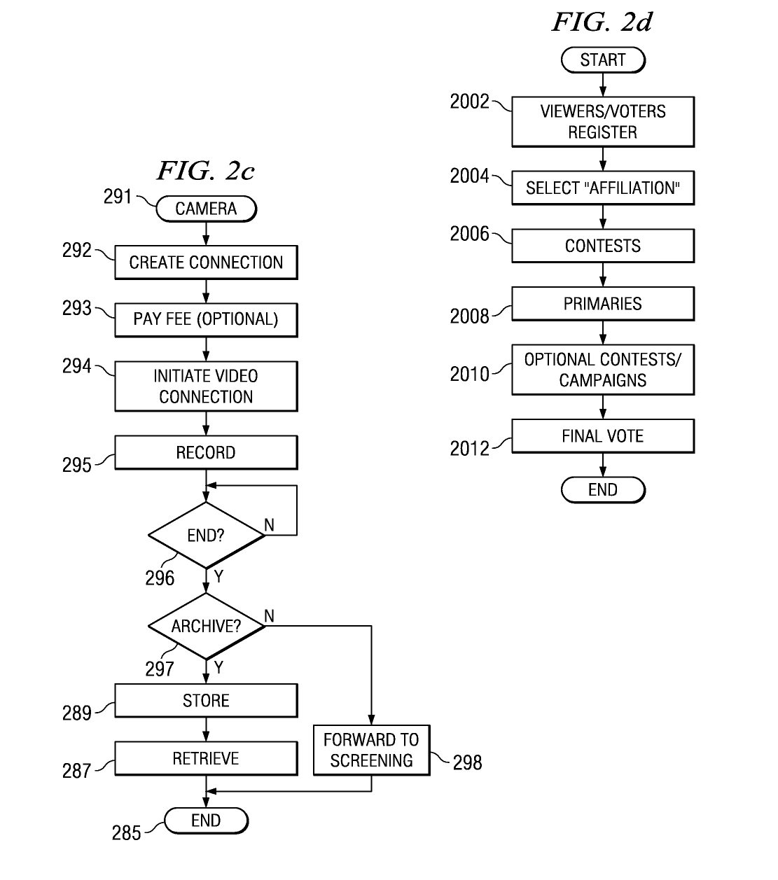

Referring now to FIG. 4, an organizational diagram depicting one embodiment of a method of organizing a broadcast of a method of selecting a political candidate according to the present disclosure is shown. FIG. 4 is meant to illustrate one of many possibly ways that the system and method for selecting a political candidate disclosed herein may be broken down into discrete episodes. The episodes could be aired by a major network, carried by a cable station, webcast, offered on the web or through a download service, or a combination of these methods. As described, a portion of the system 100 may be videotaped or prerecorded as shown at block 410. A portion of the system 100 is also held as a live event at 420. A first episode 430 may comprise a combination of taped events 410 and live performances 420. The taped events 410 may include performances, educational segments, background segments and other information conducive of preproduction. The live performance 420 may include contestant introductions and statements, competitions, speeches, debates, etc. Judges may provide commentary 440 regarding taped events 410 and live performances 420 that were include in the first episode 430. Such commentary may be included either live or prerecorded in subsequent episodes such as a second episode 450. In a similar manner, a third episode 460 may be constructed of taped events 410, life performances 420, and judges' commentary 440. This may continue through the Nth episode 470, where N is the number of episode per season or series. The final episode 480 may be a slightly different format to account for final voting or revealing of the winner, etc. For example, there may be no taped events 410 (e.g., the entire episode is live). In some embodiments, other episodes may also be entirely live.

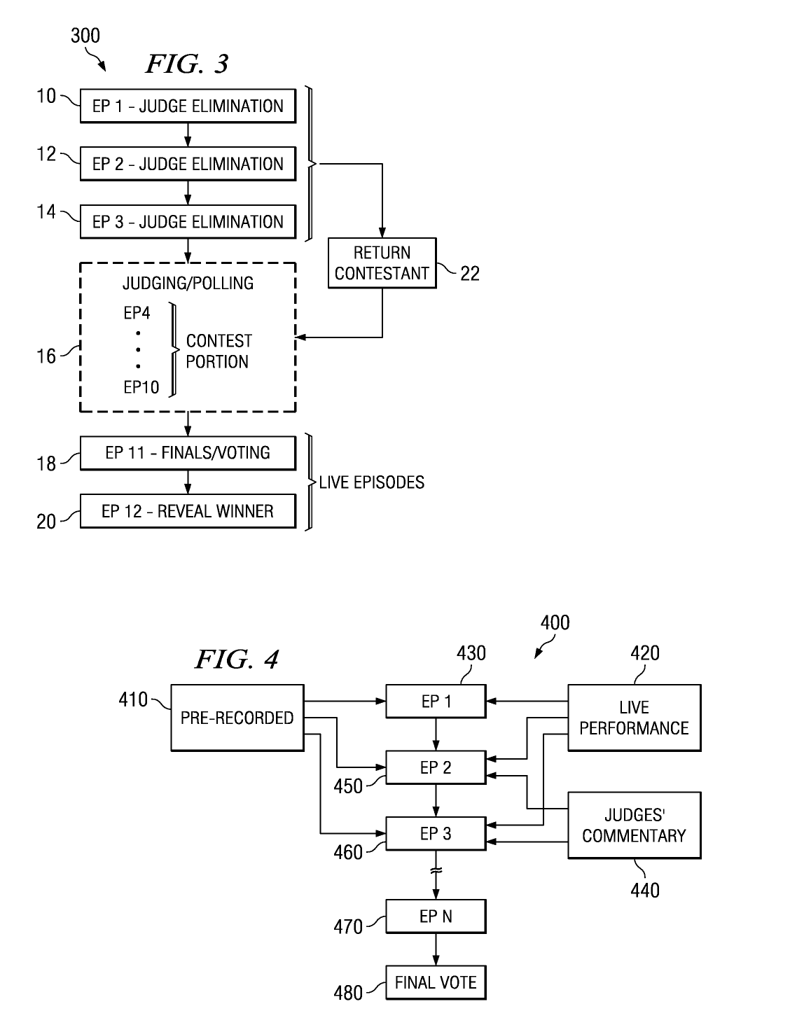

Referring now to FIG. 5 one set of possible courses of action for a successful contestant according to the system for selecting a political candidate of the present disclosure is shown. As discussed regarding FIG. 1, a winning candidate may have several options to choose from. In order to help ensure that any candidate produced by the system disclosed herein is genuinely concerned with the target office, the winner 510 may be given the option of selecting an alternate prize 520. The alternate prize 520 may be a cash payment or other reward. If the winner 510 elects the cash payment, the option to become the winning candidate will fall to the runner up. In some embodiments, the winner 510 may be provided with a cash prize that he or she may use to investigate running for office. The winner 510 may wish to determine his or her likelihood of prevailing in a general election before committing significant time and personal resources to a campaign or before declaring any official candidacy for the target office. In the event the winner 510 determines that he or she does not wish to participate in the general election as a declared candidate, the runner up may be offered the main prize of being chosen as the winning candidate.

Whether the chosen winner 510 chooses to become the candidate for the target office, or accepts the alternate prize 520, there are several options for supporting the candidate in a general election. In some case, the winner 510 will run for the target office in the general election as an independent candidate as shown at block 530. Thus, the winner 510 is not specifically associated with a political party. In this manner, the winner 510 will have a better opportunity to remain true to the principles and ideals that allowed him or her to become the winner in the system described herein. Another option would be for the winner 510 to be assisted in forming a new political party 540. A new political party would ideally be based around the ideals and principles of the winner of the contest. Here again, with a brand new political party, there is less chance that the winner 510 would feel pressured to deviate from his or her principles.

Whether the winner 510 runs in the general election as an independent 530 or under a new party 540, there is potentially a great deal of difficultly in getting on the ballot for certain elections. Most states have strenuous signature requirements before a candidate will be allowed on the ballot. Under the system and method disclosure herein, and as discussed below, there are mechanisms for dealing with the issue of ballot access. However, in the event that the winner is not able to obtain ballot access in one or more districts or jurisdictions, write in voting 550 could be used. This method would depend upon the viewing audience and other voters to write in the name of the winner 510. In some elections, such as the general election for the President of the United States, having a minimum percentage of the popular vote, can help a party obtain funding and balloting access in subsequent elections. Additionally, the individual could run as an already recognized party, as indicated by block 552.

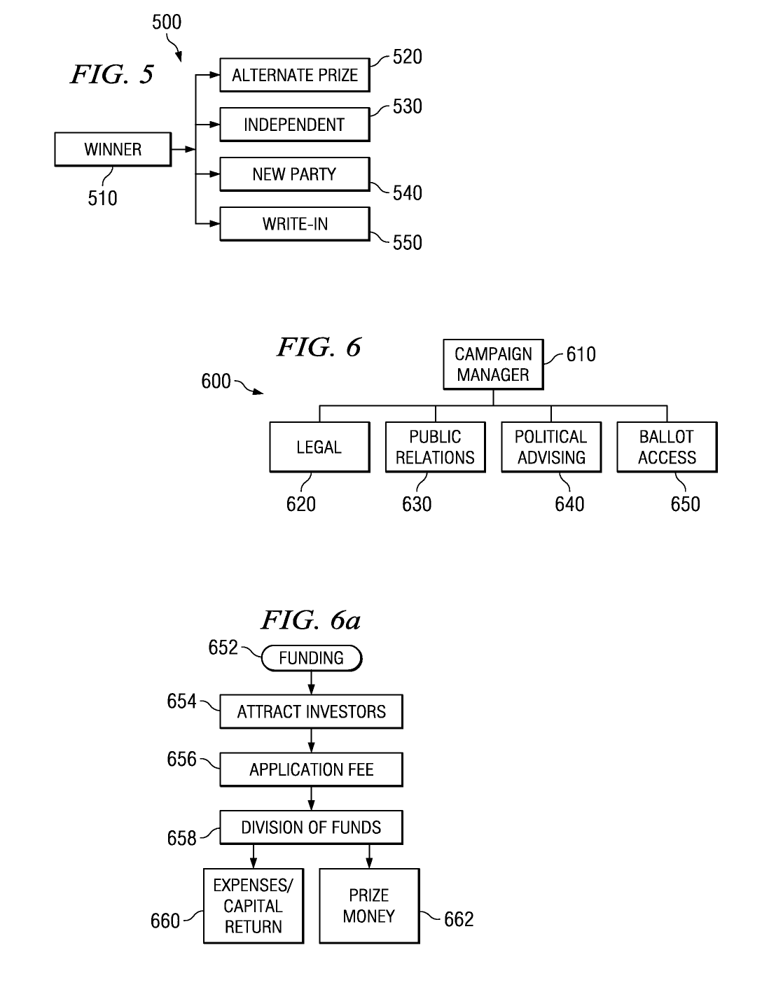

Referring now to FIG. 6, one possible structure for a campaign team for providing the winner of the system disclosed herein is shown. The campaign team 600 shown in FIG. 6 is exemplary only. In some embodiments, the team 600 will be organized differently. In other embodiments, the winner may have the option of accepting a cash prize and hiring his or her own team or replacing only part of the team 600. In the embodiment of FIG. 6, a campaign manager 610 may be in charge of the team 600. In order to comply with the myriad election and campaign rules, a legal department 620 may be under the manager 610. The legal department 620 may have attorneys or law firms, legal secretaries, paralegals, and support staff. The legal department 620 assists the rest of the organization 600 and the nominee in legally and ethically obtaining the goals of the team 600—namely, producing a favorable outcome for the nominee in a general election for the target office.

In addition to a legal department, a public relations department 620 may also be provided to the winning candidate. The public relations department 620 may employ one or more public relations professionals and may also employ one or more public relations firms. Advertising agencies could also be used. A political advising office 640 may also be a component of the campaign team 600. The political advising office 640 may employ one or more political advisors, consulting firms, polling firms, and the like. The political advising office 640 may work closely with the campaign manager 610. In some embodiments, the campaign manager 610 may properly be considered a part of the political advising office 640 because of his or her importance to the process of campaigning for the winning candidate. The political advising office 640 will provide services to the winner that relate directly to gaining popular support for the nominee. The political advising office 640 may advise the nominee regarding public opinion on topical issues. The political advising office 640 may advice the nominee regarding the best way to state his or her position regarding topics that are potentially polarizing. The political advising office 640 may advise the nominee regarding which issues will be a hard sale to the various constituency groups and which are likely to have widespread or even cross partisan support.

As discussed, there may be a great deal of bureaucratic maneuvering required for ballot access. A ballot access team 650 may be provided to execute tasks such as gathering signatures. In some embodiments, the ballot access team 650 is staffed at least partially with volunteers. In other embodiments, all or part of the ballot access team 650 will be paid. In either event, the ballot access team 650 may be sent to public places to gather signatures in each jurisdiction where this may be needed. The ballot access team 650 may also aid in increasing public awareness of locales having overly strict ballot access rules. The ballot access team may also attend rallies and distribute campaign posters, and other promotional items when needed. Of course, the company would have to be funded, as indicated by a block 652.

Referring now to FIG. 6a, there is illustrated a flow chart depicting the overall funding operation. It is anticipated with the contest that there will be prize money provided. This is potentially necessary in order to attract individuals to the campaign. As is well known in the art, any type of political campaign, to be successful, requires a significant amount of funding. However, it is also noted that most campaigns have very strict rules to define who can contribute such funds to a candidate, when these funds can be distributed, etc. All of these must be considered when setting up the funding. However, in one embodiment, it is anticipated that funding will be provided initially as a prize to the candidate. Thus, this will be the candidate's own money, when transferred to the candidates. In order to initiate the funding, there will be a funding process, which is initiated at a block 652 and then proceeds to a function block 654 wherein, in one embodiment, there will be an effort to attract investors into the overall contest for initial capitalization of the contest. There can also be funds received from application fees, as indicated by a function block 656, which could also include revenue from advertising, revenue from database sales, etc. There are many ways that any kind of contest could be funded and provide a significant prize for the eventual winner. Thereafter, the amount of money allocated for the prize (assuming that the investors may want to have some type of return for themselves) would then be provided and made available for a division of funds. This is indicated by a function block 658. This division of funds will be a certain portion that is allocated for expenses and capital return, as indicated by a function block 660 and another portion of the funds would be allocated for prize money, as indicated by a function block 662. The prize money, as indicated hereinabove, can either be offered to the potential candidate outright or it could be utilized to fund the campaign.

Referring now to FIG. 6b, there is illustrated a flow chart for defining how an infrastructure could be created in the event that the candidate accepts the campaign path. Even if the potential candidate has not accepted a campaign path, there still must be some type of potential or actual infrastructure for the campaign created prior to the time that the candidate wins. This could be for two purposes. The first purpose is to make sure that the potential candidate, once he/she has elected to go forward with a campaign, would allow them to very quickly enter into a full campaign mode. The second is to provide additional advertising and program footage showing the selection process of the campaign staff. This may be of significant interest to viewers during a campaign to apprise them of what actually goes on in creating or mounting a successful campaign.

The flow chart of FIG. 6b is initiated at a block 664 and then proceeds to a block 666 wherein qualified campaign staff are attracted. As noted hereinabove, however, this is only one approach. To attract qualified campaign staff, these potential staff members would be provided contingent contracts, as indicated by a function block 668, which would contractually bind them to working with the winner of the contest, should they choose to go forward with a campaign, which contractual obligations would require them to take a certain position in the campaign. Once all of these contingent contracts are collected, there would be a complete campaign infrastructure put in place. In fact, the actual interviewing of the various campaign staff could be part of the program footage associated with the contest. It would be doubtful that viewers would vote on these particular campaign staff; rather, they would be chosen by qualified individuals that could evaluate the aspects necessary to mount a successful campaign. Once the staff has been assembled and the contracts executed, then these potential staff members could be offered to the winner, as indicated by a block 670. Once the winner is announced, that winner has two options, take the money or go forward with a campaign. This is indicated by a decision block 672. If they take the money, the program flows to a function block 674 and the campaign is terminated. However, if the winner accepts the campaign route, the program will then flow to a function block 676 wherein the campaign would be funded. This could be in the form of a trust fund or some type of fund that is given to the user basically to make sure that any campaign rules are not violated at a later time. This is essentially a line of demarcation that allows the individual to go forward with their campaign. If the campaign is funded and if the winner accepts all the staff members, the various contingent contracts will be triggered, as indicated by a function block 678 and then the campaign is continued as indicated by a function block 680. This funding, of course, can take on many various modes.

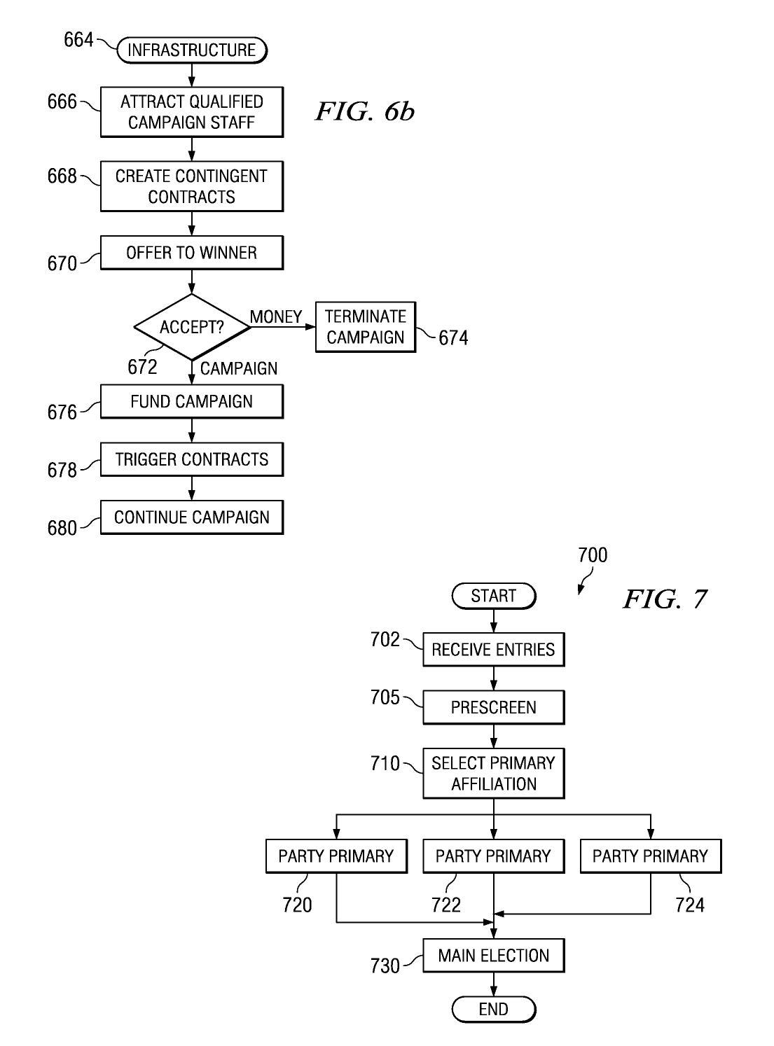

Referring now to FIG. 7, a flow diagram 700 of another embodiment of a method for selecting a political candidate according to aspects of the present disclosure is shown. The flow diagram 700 illustrates an embodiment where the nominee for the target office is selected through one or more primaries. Candidates or applications may be accepted at step 702 and prescreened at step 705. As previously described, the candidates may be accepted from a wide variety of sources including self nominations or third-party nominations. The candidates may be prescreened based on a number of criteria including statutory requirements for the target office, willingness to participate, etc. However, as with other embodiments described herein, the prescreening is not mean to deprive eligible candidates from participation, but rather to make the system workable for the large number of candidates that may desire to participate.

Following acceptance of candidates at step 702 and prescreening at step 705, participating voters or viewers may be required to declare a party or primary affiliation at step 710. In some embodiments, the party or primary platforms will be drawn along general ideological lines (e.g., conservative, liberal, or moderate) but they need to necessarily be so. The present disclosure provides a means for minor interests to be given a main stream voice, and as such, a party or primary race could be based upon a very specific or narrow grouping of interests (e.g., drug issues, military issues, education, or the environment). In some embodiments, the voters will be a viewing audience such as the viewing audience 136 of FIG. 1. A registration process may be provided to verify that each participating voter is a real person. Screening may also be provided to determine if the voter is actually eligible to vote in the general, state-run election for the target office. The registration and/or screening could be accomplished using a secure, computerized system. In some embodiments, a web-based system will be used. This may be part of a website or portal associated with the system described herein. In this manner, the “primaries”, will be securely executed, and easily accessible to the voters. Information and education regarding the primaries of the system shown in FIG. 7, as well as primaries in general, could also be provided via the associated website and/or portal.

Following the voters declaring a primary or party affiliation at step 710, the primaries associated with each of these groups will be executed. Three primaries are shown taking place at steps 720, 722, and 724 but the present disclosure is not meant to be limited to the number shown. These primaries may be conducted sequentially or in parallel. The candidates may also be required to declare a party or primary affiliation but could also be allowed to participate in more than one of the primaries. All or a portion of the primaries may be televised, webcast, or otherwise distributed. In some embodiments, the primaries may be broken into one or more contests or events such as described with respect to FIGS. 1-2. For example, skills testing and possibly a judges panel could be used to facilitate the events. The candidate pool for each primary may be sequentially reduced until only one remains. The voters associated with each of the primaries may participate online, via television, telephone, or other means. Security measures may be taken to ensure the integrity of the primaries. Driver's license registration, unique voter identification numbers, pin numbers, or voter identification cards could be used. Some embodiments will also provide biometric verification such as fingerprinting or retinal scanning.

Following the selection of the final primary candidates, a main election may be held at step 730. Here, the winners of the primaries may be pitted against one another to win the votes of all registered voters or viewers. The general election at step 730 may also be conducted as a series of contest events. These may be produced as one or more television episodes, webcasts, or other distributions. As with the primaries of steps 720, 722, and 724, security measures may be put in place to ensure the integrity of the election. As in other embodiments, when a winner has been chosen, he or she may be presented multiple options such as the accepting the official nomination for the target office, accepting an alternate prize alternate prize, or other options such as those described with respect to FIG. 5.

It will be appreciated by those skilled in the art having the benefit of this disclosure that this invention provides a system and method for selecting a political candidate. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method for choosing a political candidate, comprising:
establishing a location providing applications for persons to participate in a contest-based political nominee generating event for a predetermined target political office;
receiving completed applications for the contest-based event from a plurality of potential candidates;
pre-screening the applications received to produce a contestant pool of persons who applied who also meet the requite qualifications of the target political office;
judging a first series of tasks performed by individual members of the contestant pool;
eliminating at least one contestant from the contestant pool based on the judging;
providing a viewing audience with access to observe a second series of tasks performed by the remaining individual members of the contestant pool;
providing commentary on the performance of the remaining individual members of the contestant pool in performing the second series of tasks; and
taking a vote of the viewing audience to eliminate at least one of the remaining members of the contestant pool.

2. The method of claim 1, further comprising repeating the steps of providing a viewing audience with access to observe a second series of tasks performed by the remaining individual members of the contestant pool, providing commentary on the performance of the remaining individual members of the contestant pool in performing the second series of tasks, and taking a vote of the viewing audience to eliminate at least one of the remaining members of the contestant pool, until a single contestant remains in the contestant pool.

3. The method of claim 2, further comprising providing the single contestant a pre-paid campaign staff operable to assist the single contestant in obtaining official nomination and ballot access for the target office.

4. The method of claim 2, further comprising allowing the single contestant the option of having a campaign staff providing services assist the single contestant in obtaining official nomination and ballot access for the target audience and receiving a cash prize.

5. The method of claim 4, further comprising offering the campaign staff and services to assist the single contestant to a runner up.

6. The method of claim 1, wherein the target audience is the Presidency of the United States of America.

7. The method of claim 1, wherein providing a viewing audience with access to observe a second series of tasks performed by the remaining individual members of the contestant pool further comprises televising the second series of tasks performed by the remaining individual members of the contestant pool.

8. The method of claim 1, further comprising operating a web site with instructions regarding how the method for choosing a political candidate operates.

9. The method of claim 1, further comprising providing a web site for accepting applications for persons to participate in the contest-based political nominee generating event for the predetermined target political office.

10. The method of claim 1, wherein taking a vote of the viewing audience to eliminate at least one of the remaining members of the contestant pool further comprises taking a vote by telephone.

11. The method of claim 1, wherein taking a vote of the viewing audience to eliminate at least one of the remaining members of the contestant pool further comprises taking a vote via a webpage.

12. The method of claim 1, wherein taking a vote of the viewing audience to eliminate at least one of the remaining members of the contestant pool further comprises taking a vote via the internet.

13. The method of claim 1, wherein judging a first series of tasks performed by individual members of the contestant pool further comprises judging a series of physical endurance tests performed by individual members of the contestant pool.

14. The method of claim 1, wherein judging a first series of tasks performed by individual members of the contestant pool further comprises judging a response to a series of questions posed to the individual members of the contestant pool.

15. The method of claim 1, further comprising hosting a debate between the individuals of the contestant pool that is observed by the viewing audience.

16. The method of claim 1, further comprising recording the judging of a first series of tasks performed by individual members of the contestant pool and eliminating at least one contestant from the contestant pool based on the judging.

17. The method of claim 16, further comprising providing distributing the recording as a series of episodes.

18. The method of claim 1, wherein providing a viewing audience with access to observe a second series of tasks performed by the remaining individual members of the contestant pool comprises providing a televised event corresponding to the second series of tasks performed by the remaining individual members of the contestant pool and distributing the televised event to the viewing audience.

19. A system for choosing a political candidate for a target office, comprising:
a location providing applications for persons to participate in a contest-based political nominee generating event for a predetermined target political office, and receiving completed applications for the contest-based event from a plurality of potential candidates;
a pre-screening center that screens the completed applications to produce a contestant pool of persons who applied who also meet the requite qualifications of the target political office;
a facility for a viewing audience to observe a second series of tasks performed by the remaining individual members of the contestant pool;
a judging panel that judges a first series of tasks performed by individual members of the contestant pool and eliminates at least one contestant from the contestant pool based on the judging and provides commentary on the performance of the remaining individual members of the contestant pool in performing the second series of tasks; and
a voting system for polling the viewing audience to eliminate at least one of the remaining members of the contestant pool.

20. The system of claim 19, further comprising a website made available over the internet providing detailed information concerning the system for choosing a political candidate.

21. The system of claim 20, wherein the website also provides educational material regarding the target office.

22. The system of claim 19, wherein the voting system further comprises an electronic voting system.

23. The system of claim 19, wherein the voting system is a telephone-based voting system.

24. The system of claim 19, wherein the voting system is an internet voting system.

25. The system of claim 19, wherein the facility for a viewing audience to observe a second series of tasks performed by the remaining individual members of the contestant pool comprises a television studio location.

26. The system of claim 19, wherein the facility for a viewing audience to observe a second series of tasks performed by the remaining individual members of the contestant pool comprises a series of broadcast television shows.

27. The system of claim 19, wherein the facility for a viewing audience to observe a second series of tasks performed by the remaining individual members of the contestant pool comprises a download service.

28. A method for selecting a candidate for a political office via a series of televised competitions, the method comprising:
accepting completed applications for possible contestants for the program;
pre-screening the applications and producing a set of contestants
producing a first set of episodes showing a set of competitions observed by a judging panel, the judging panel voting to eliminating at least one of the contestants from the series;
producing a second set of episodes showing a second set of competitions observed by a judging panel and a viewing audience, the viewing audience eliminating all but one contestant from the series;
wherein the judging panel provides commentary to the viewing audience regarding the contestants and the second set of competitions.

29. The method of claim 28, further comprising returning at least one contestant who was eliminated back to the series before the step of producing a second set of episodes.

30. The method of claim 29, wherein producing a second set of episodes further comprises producing an episode wherein a winner of the series is chosen based upon the popular vote of the viewing audience.

31. The method of claim 30, further comprising producing an episode wherein the winner of the series is revealed.

32. The method of claim 31, further comprising producing an episode wherein the winner of the series is allowed to choose to receive the services of a prepaid election campaign staff or a monetary prize.

33. The method of claim 32, wherein a runner up is chosen to receive the services of the campaign staff.

35. A system for choosing a political candidate for a target office, comprising:
a plurality of application reception stations to receive contestant applications;
a screening center that eliminates contestants without required credentials to run for the target office in a general election for the target office;
a judging panel that eliminates a first predetermined number of contestants from eligibility to win;
a production studio producing a series of programs for viewing by a viewing audience wherein the contestants engage in a series of competitions illustrating their suitability for the target office; and
a voting system for polling the viewing audience to determine a winner of the series of competitions.

36. The system of claim 35, further comprising providing the winner with a campaign team.

37. The system of claim 36, wherein the campaign team is operable to obtain requisite signatures needed for ballot access in a plurality of voting districts.

38. The system of claim 36, wherein the campaign team is operable to advise the winner regarding the legality of a campaign for the target office.

39. The system of claim 35, wherein the judging panel comprises at least one former office holder of the target office.

40. The system of claim 35 wherein the screening center accepts third party nominations and delays verification of the credentials.

41. A method for selecting a political candidate, comprising:
conducting a first series of screening events on one at least one group of potential candidates to produce a set of potential nominees;
publicly conducting a second series of screening events on the set of potential nominees;
conducting a series of voting processes to sequentially reduce the set of potential nominees to a single nominee.

42. The method of claim 41, further comprising providing the nominee with a paid support staff to aid the nominee in obtaining ballot access.

43. The method of claim 42, further comprising providing the nominee with a paid staff to aid the nominee in obtaining ballot access by obtaining a requisite number of signatures needed for ballot access.

44. The method of claim 41, further comprising providing the nominee with a choice between having a paid staff to aid the nominee in obtaining ballot access and receiving an alternate prize.

45. The method of claim 44, wherein the alternate prize is monetary and of substantially similar value as the paid staff.

46. The method of claim 41, wherein the first series of screening events comprise verifying that each of the group of potential candidates is eligible to run for the target office in a general election.

47. The method of claim 41, wherein the second series of screening events comprises speeches and testing events.
